(19) United States
(12) Patent Application Publication
(10) Pub. No.: US 2026/0212403 A1
(43) Pub. Date: Jul. 23, 2026

(54) IDENTIFYING SUBSTITUTE ITEMS BASED ON USER SENTIMENT USING ARTIFICIAL INTELLIGENCE

(71) Applicant: Adjusto, Inc., Superior, CO (US)

(72) Inventors: Michael Balarezo, Superior, CO (US); James Reid Greer, San Francisco, CA (US); Bradley Klingenberg, Boulder, CO (US)

(21) Appl. No.: 19/456,951

(22) Filed: Jan. 22, 2026

Related U.S. Application Data
(60) Provisional application No. 63/748,311, filed on Jan. 22, 2025.

(51) Int. Cl. G06Q 30/0601; G06Q 40/08

(52) U.S. Cl. CPC G06Q 30/06313; G06Q 40/083; G06Q 40/09

(57) ABSTRACT

Techniques described herein enable a substitute item to be identified based on user sentiment using artificial intelligence. Items similar to a target item are identified based on search of an item database. Features of the target item and similar items are extracted using one or more feature extraction models. A similarity score for each similar item is determined based on the extracted features. A fairness score is determined for one or more of the similar items. One or more substitute items for the target item are identified based on the similarity score and the fairness score.

### BACKGROUND

### Technical Field

The present application relates generally to identifying substitute goods, and more particularly, to identifying substitute items based on user sentiment using artificial intelligence (AI).

### Description of the Related Art

It is often useful to identify substitute items for a target item. For example, in processing insurance claims, substitute items for a target item lost by fire, flood, theft, etc. are identified.

It is with respect to these and other considerations that the embodiments described herein have been made.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings:

FIG. 1 is a context diagram illustrating an environment for identifying substitute items based on user sentiment in some embodiments.

FIG. 2 is a context diagram of a system that provides functionality to identify substitute items based on user sentiment in some embodiments.

FIG. 3 is a logical flow diagram illustrating a process for identifying substitute items based on user sentiment using artificial intelligence in some embodiments.

FIG. 4 is a logical flow diagram illustrating a process for identifying candidate substitute items using an item database in some embodiments.

FIG. 5 is a block diagram illustrating logic for obtaining one or more normalized target items in some embodiments.

FIG. 6 is a block diagram illustrating logic for identifying similar items based on a target item in some embodiments.

FIG. 7 is a block diagram illustrating logic for scoring similar items in some embodiments.

FIG. 8 is a block diagram illustrating logic for filtering scored similar items in some embodiments.

FIG. 9 is a block diagram illustrating logic for determining fairness scores for similar items in some embodiments.

FIG. 10 is a block diagram illustrating logic for determining a recommended substitute item in some embodiments.

FIG. 11 is a system diagram illustrating one implementation of a computing system usable for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

Any artificial intelligence (i.e., “AI”) model discussed herein may be optimized for performance on a relevant task by training or fine-tuning. The term “training” typically refers to modifying weights, such as randomly or pseudo-randomly initialized weights, of an AI model to improve performance of the AI model with respect to a relevant task. For example, a weighted linear regression model is often trained from arbitrarily initialized weights. The term “fine-tuning” typically refers to optimizing a base AI model having pre-trained weights to improve performance of the AI model with respect to the relevant task. For example, a base AI model such as GPT-4 is often fine-tuned.

It is often useful to identify a substitute item for a target item. For example, an insurance claim may identify target items destroyed in an event such as a fire or flood. An adjuster then valuates each item in the list, such as by identifying substitute items, to determine how to process the claim. Conventional techniques for identifying substitute items are cumbersome, error-prone, and slow. As a result, in the case of insurance claim processing, shortcuts that impact a final payout of depreciation are often taken. For example, claims volume, fatigue, or inattention to detail in proper substitute selection impacts the accuracy of the valuation. Shortcuts like selecting a first item in a Google search that falls under the submitted price of a target item may further impact the accuracy. These practices can lead to disputes when a payout is perceived as unfair, increasing the amount of time and processing resources required to process a claim. Claimants that believe they are being treated unfairly may also change insurance carriers. In some cases, conventional practices for identifying substitute items can also lead to carriers paying out more than a fair value of a target item. Improved techniques for identifying fair and accurate substitute items are needed.

Embodiments discussed herein enable identifying substitute items based on user sentiment using artificial intelligence. In some embodiments, items similar to a target item are identified based on search of an item database such as Google Shopping or Amazon. Features of the target item and similar items are extracted using one or more feature extraction models. A similarity score for each similar item is determined based on the extracted features. A fairness score is determined for each of the similar items. In various embodiments, the fairness score is determined based on user sentiment or a contextual insight based on the target item. One or more substitute items for the target item are selected from the similar items based on the similarity score and the fairness score. In various embodiments, the one or more substitute items are selected using any combination of the similarity score and the fairness score, such as a weighted combination.

By performing in some or all of the ways described above, substitute items are determined based on user sentiment using artificial intelligence. Techniques described herein improve the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by alleviating the need for a user to manually identify substitute items, techniques described herein alleviate the need to display various interfaces or applications used to manually search for substitute items, improving the functioning of computers. Additionally, by improving the accuracy of substitute item identification, processing resources that would otherwise be dedicated to providing interfaces for ongoing dispute or communications regarding substitute items can be redirected to other uses.

Further, for at least some of the domains and scenarios discussed herein, the processes described herein as being performed automatically by a computing system cannot practically be performed in the human mind, for reasons that include that the starting data, intermediate state(s), and ending data are too voluminous and/or poorly organized for human access and processing, and/or are a form not perceivable and/or expressible by the human mind; the involved data manipulation operations and/or subprocesses are too complex, and/or too different from typical human mental operations; required response times are too short to be satisfied by human performance; etc.

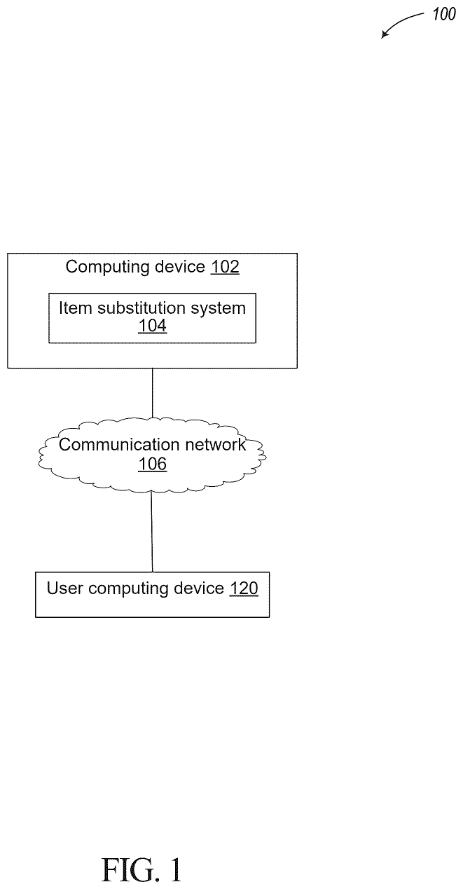

FIG. 1 is a context diagram illustrating an environment 100 for identifying substitute items based on user sentiment in some embodiments. Environment 100 includes computing device 102 and user computing device 120, which communicate using communication network 106. Computing device 102 is a server, computing device, cloud computing environment, virtual machine, or some other computing system. Computing device 102 implements item substitution system 104, which identifies one or more substitute items for a target item based on user sentiment using artificial intelligence. In some embodiments, the one or more substitute items are provided to user computing device 120 via communication network 106. In some embodiments, item substitution system 104 is made accessible to user computing device 120 through an application programming interface (i.e., “API”), as software as a service (i.e., “SaaS”), etc.

In various embodiments, user computing device 120 is a smartphone, laptop, desktop computer, virtual machine, etc. In one non-limiting example, user computing device 120 is a computing device used by an insurance adjuster.

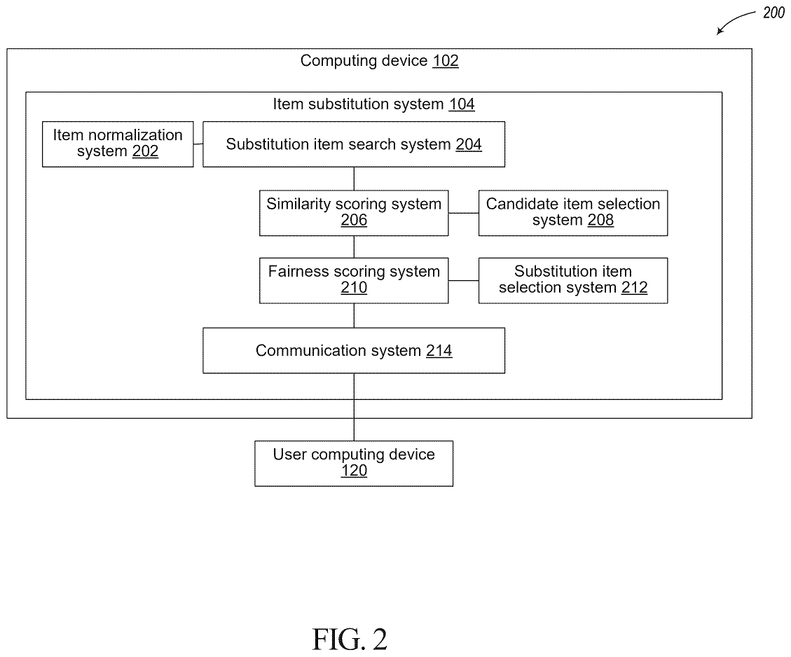

FIG. 2 is a context diagram of a system 200 that provides functionality to identify substitute items based on user sentiment in some embodiments. Computing device 102 includes item substitution system 104, which includes item normalization system 202, substitution item search system 204, similarity scoring system 206, candidate item selection system 208, fairness scoring system 210, substitution item selection system 212, and communication system 214.

Item normalization system 202 is configured to produce normalized target items based on input indicating the target items. In some embodiments, item normalization system 202 extracts information from the input and creates a structured data object representing the normalized target items. In some embodiments, item normalization system 202 enriches the structured data object with additional information regarding the target items. In one example where the input is an insurance claim list, item normalization system extracts information from the insurance claim list and creates a structured data object representing each target item in the claim list. Item normalization system 202 enriches the structured data object with additional information about the items, such as a brand of an item, an estimated value of the item, etc.

In some embodiments, item normalization system 202 identifies a contextual insight regarding a target item, and enriches the structured data item using the contextual insight. A contextual insight captures features of the target item, a person associated with the target item, or other information that may affect a fairness of a substitution item for the target item or other items. The contextual insight may indicate a sentimentality of the target item, a subjective value of the target item, a demographic of a person associated with the target item, a level of quality of the target item, a rarity of the target item, etc. The demographic of the person associated with the target item may be an interest, hobby, persona, attitude, character trait, or other characteristic.

In some embodiments, item normalization system 202 identifies whether an input image used to identify the target item is synthetic or altered, exists in an image database, or includes metadata inconsistent with the target item. For example, where the target item is known to be located in Florida, but an image of the target item includes metadata indicating that the image was taken in New York, item normalization system 202 flags the target item as including potentially incorrect or contradictory information.

In some embodiments, item normalization system 202 compares the target item to known patterns of fraud to determine whether the target item is likely to be fraudulent. In the case of insurance claims, information regarding the target item may be submitted with an insurance claim despite the claim on the target item being unsubstantiated. In one example, based on detecting a pattern of fraudulent insurance claims regarding boats lost in fires, a boat lost in a fire is flagged as potentially fraudulent. In some embodiments, the target item is flagged based on a similarity with a pattern of known fraud satisfying a similarity threshold. In one example where vehicles of a particular make and model are associated with a pattern of fraud, the similarity threshold causes the target item to be flagged where the target item is a vehicle with the make and model.

In some embodiments, item normalization system uses contextual information from a set of items to determine whether the target item is anomalous or indicative of fraud. In one example, item normalization system 202 determines that the set of items includes unusually expensive golf clubs, but does not contain any other sporting gear. Accordingly, item normalization system 202 flags the golf clubs for review. In another example, the item set includes multiple items of a same kind in an unusual quantity compared to other item sets including an item of the same kind. For example, the item set may include fifteen computer tablets or six treadmills, whereas item sets typically include two computer tablets and one treadmill. Based on the unusual quantity, item normalization system flags the computer tablets and treadmills for review.

In some embodiments, item normalization system 202 incorporates demographic or geographic data associated with the item set or a user computing device that provides the item set to determine whether the item set is anomalous or indicative of fraud. In one example, a person having a demographic of a person associated with the item set may own, on average, items having a particular quality, quantity, make, model, etc. Based on a characteristic of the item set or an item thereof deviating from the average of a person having the demographic by more than a threshold, such as 1, 2, or 3 standard deviations, the item set or item thereof is flagged for review.

Flagging the target item may include flagging the target item for review by a user. Flagging the target item for review may include providing a notification to a user device requesting review of the target item. Flagging the target item may include providing a notification to a user device requesting additional information regarding the target item. In some embodiments, a substitute item is not determined for the flagged target item until the flag is resolved, such as by manual review of the target item or provision of additional information regarding the target item.

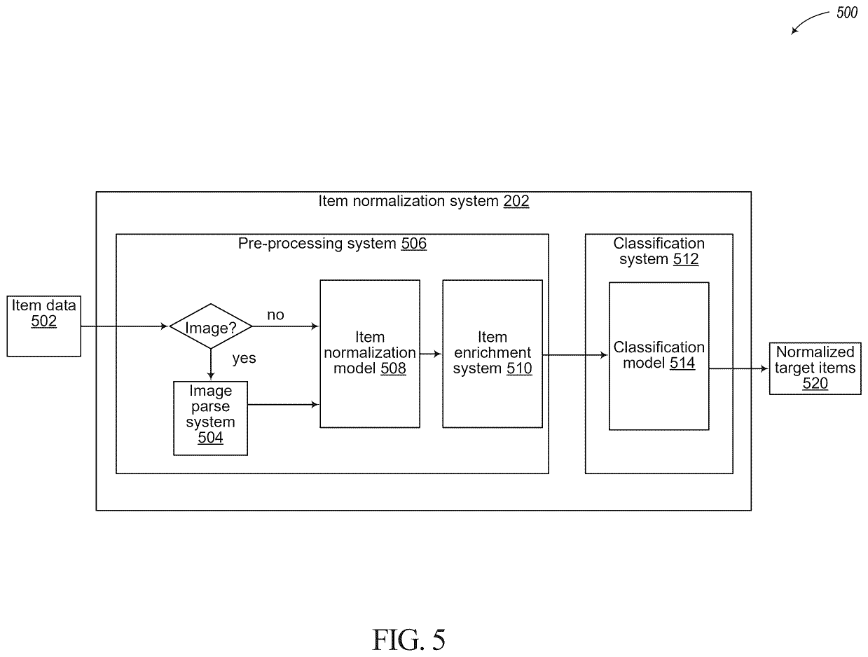

Item normalization system 202 is discussed in further detail with respect to FIG. 5. In various embodiments, item normalization system 202 provides the normalized target items to substitution item search system 204.

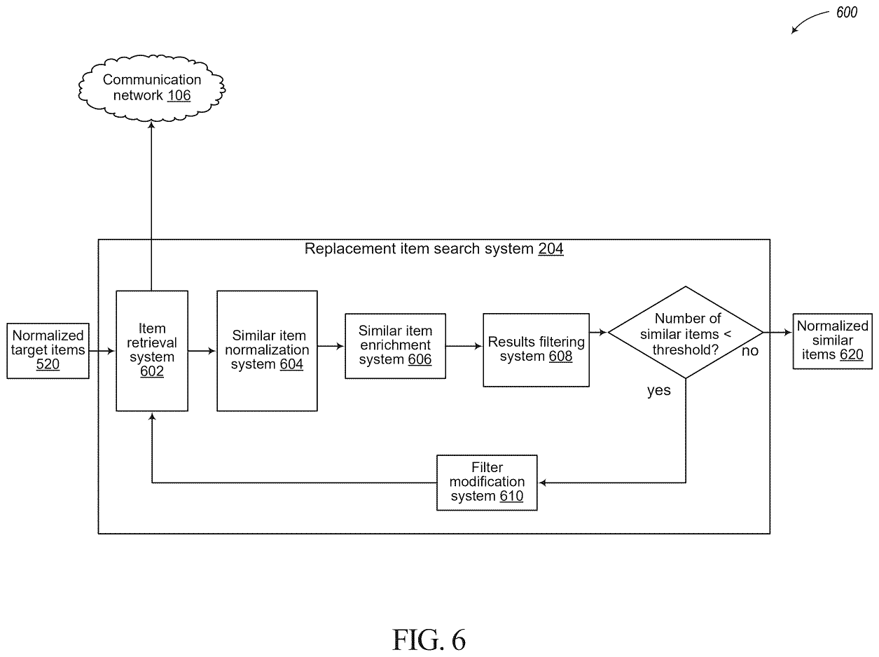

Substitution item search system 204 is configured to search one or more item databases for candidate substitute items based on a target item, such as a target item of the normalized target items created using item normalization system 202. Substitution item search system is discussed in further detail with respect to FIG. 6. In some embodiments, substitution item search system 204 provides the similar items to similarity scoring system 206.

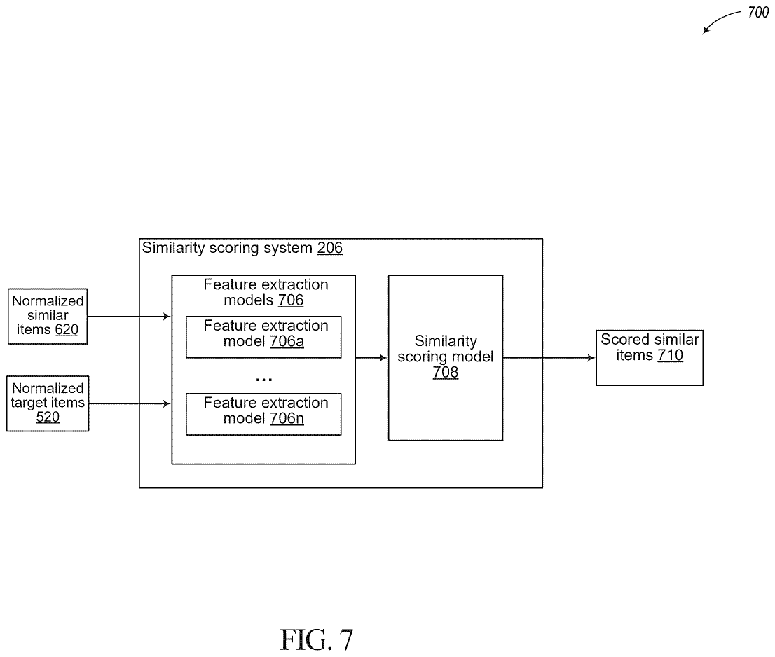

Similarity scoring system 206 is configured to determine a similarity score for a candidate item that captures a similarity of the candidate item to a target item. Similarity scoring system 206 is discussed in further detail with respect to FIG. 7. In some embodiments, similarity scoring system 206 provides the similarity score to candidate item selection system 208.

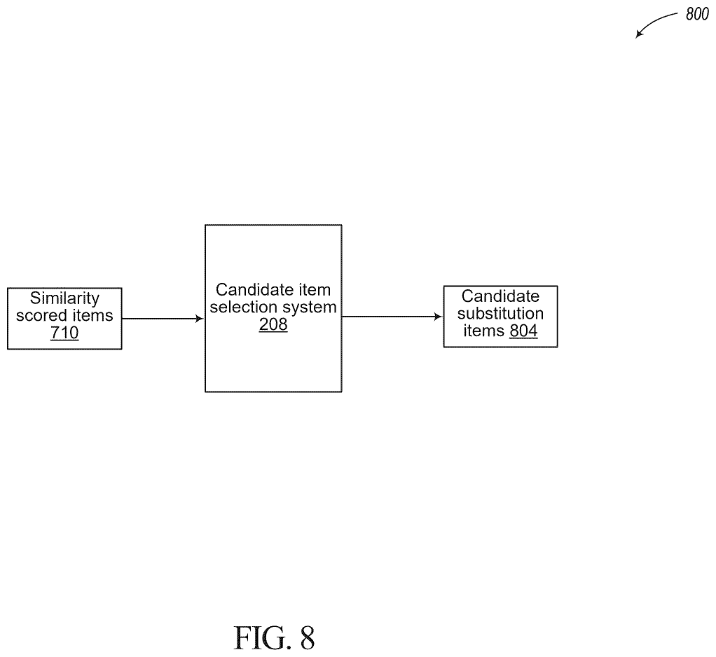

Candidate item selection system 208 is configured to determine a candidate substitution item (i.e., candidate item) for a target item based on similarity scores of the candidate substitution items. Candidate item selection system 208 is discussed in further detail with respect to FIG. 8. In some embodiments, candidate item selection system 208 provides the candidate item to fairness scoring system 210.

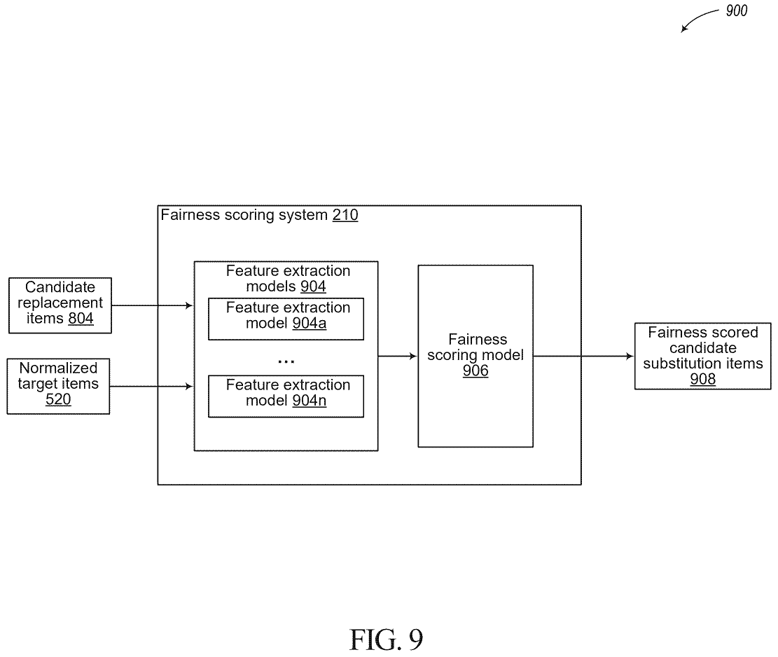

Fairness scoring system 210 is configured to determine a fairness score for the candidate item that captures a fairness of the candidate item as a substitution for the target item. For example, when a price of the target item is $10,000 and a price of the substitute item is $1,000, the fairness score may be relatively low. When a price of the target item is $10,000 and the price of the target item is $10,000, the fairness score may be relatively high. In various embodiments, fairness scoring system 210 includes one or more artificial intelligence (i.e., “AI”) models trained or fine-tuned to determine the fairness score. In some embodiments, the one or more AI models are trained or fine-tuned using a training dataset that includes pairs of target items and substitute items with corresponding fairness labels. In some embodiments, the fairness labels for the training dataset are generated based on user input. For example, a user is presented with a target item and a substitute item and is asked to determine a fairness of the substitute item. Based on feedback from the user, a fairness label is created for the target item-substitute item pair of the training dataset. By incorporating subjective fairness measures, item substitution system 204 may identify a substitute item that is subjectively perceived as fair by users. Fairness scoring system 210 is discussed in further detail with respect to FIG. 9. In some embodiments, fairness scoring system 210 provides a fairness score to substitution item selection system 212.

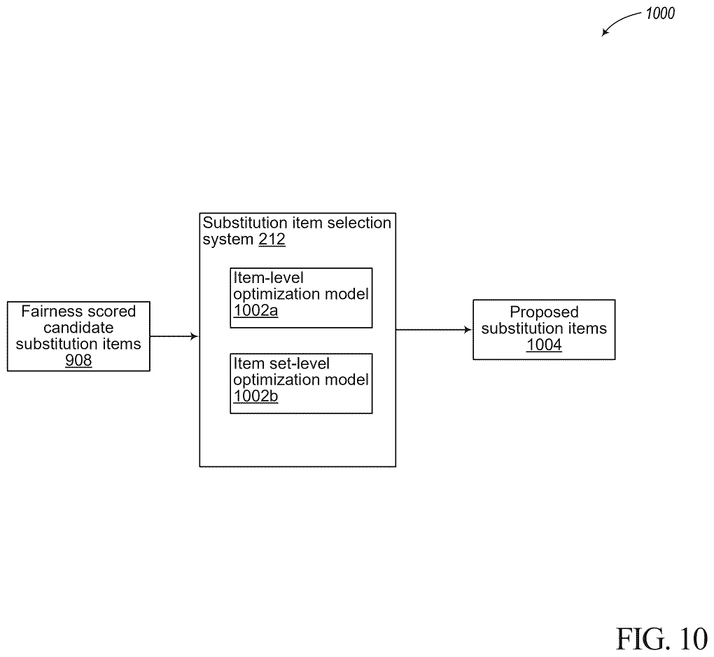

Substitution item selection system 212 is configured to select a substitute item based on the similarity score produced using similarity scoring system 206 and the fairness score produced using fairness scoring system 210. Substitution item selection system 212 is discussed in further detail with respect to FIG. 10. In some embodiments, substitution item selection system 212 provides an indication of the substitute items to user computing device 120 using communication system 214.

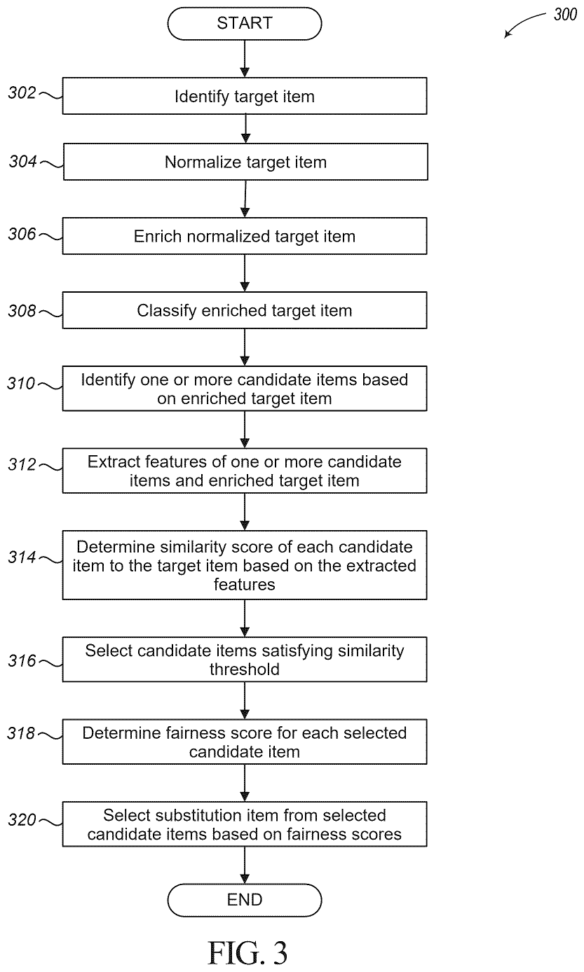

FIG. 3 is a logical flow diagram illustrating a process 300 for identifying substitute items based on user sentiment using artificial intelligence in some embodiments.

Process 300 begins, after a start block, at block 302, where a target item is identified. Identifying the target item includes obtaining a digital representation of a tangible or intangible item. The target item may include a description of the tangible or intangible item, structured or unstructured data regarding the tangible or intangible item, etc. In one example where the tangible item is a vehicle, identifying the target item includes obtaining a description of the vehicle.

In some embodiments, the target item is identified from a loss sheet that includes one or more items lost during an accident, fire, flood, due to theft, etc. In various embodiments, the target item is identified based on an item in an online shopping cart of a user, an item in a previous order of a user, an item in a recipe, an item in a materials list, an item in a video or image, etc. In one example where a user has an item in their online cart and the item becomes out-of-stock, the out-of-stock item is the target item such that possible substitute items can be identified and added or recommended to be added to the shopping cart. In another example, a user is allergic to an item in a recipe. The item in the recipe is identified as the target item, such that possible substitute items are identified. After block 302, process 300 continues to block 304.

At block 304, the target item is normalized. In some embodiments, normalizing the target item includes producing structured data according to a standardized schema. In one non-limiting example, normalizing the target item includes parsing a description of the target item and producing a JavaScript Object Notation (JSON) object that represents the target item. In some embodiments, normalizing the target item includes identifying an item number, a stock keeping unit (SKU) of the target item, or other standardized identifier of the target item. In one example, a description of a shirt is normalized into a stock keeping unit of the. Normalizing the target item enables improved identification of potential substitution items.

In various embodiments, the target item is normalized using a trained AI model such as a large language model. In some embodiments, the trained AI model is trained or fine-tuned using examples of target item descriptions and corresponding structured data. In some embodiments, the target item description is provided to the trained AI model with a prompt describing a standardized schema. Table 1 below illustrates one non-limiting example of a normalized target item.

TABLE 1
Example Normalized Target Item

```
{
  id: '69ba75b0-342d-4e96-9c39-c27944f26987'
  description: 'Ralph Lauren Polo shirt',
  room: 'Master Bedroom',
  store: 'Ralph Lauren',
  quantity: 3,
  age: '0',
  price: '69.99'
}
```

### Table 1: Example Normalized Target Item

As illustrated in Table 1, the normalized target item is a shirt. Various fields corresponding to the target item are included, such as a description field corresponding to a description of the target item, a room field corresponding to a location of the target item, a store field corresponding to a retailer or place of purchase of the target item, a quantity field corresponding to a quantity of the target item, an age field corresponding to an age of the target item, and a price field corresponding to a price of the target item. In some embodiments, the normalized target item is created based on user input, such as in a loss sheet. After block 304, process 300 continues to block 306.

At block 306, the normalized target item is enriched. In various embodiments, the normalized target item is enriched by extracting one or more features from the item description such as a name, price, store name, brand, color, genericness, etc. In some embodiments, the description of the target item includes a policyholder's description of the item such as “Ralph Lauren Polo Shirt,” a price of “69.99,” etc. as shown in Table 1. In some embodiments, enriching the normalized target item includes deriving one or more derived features such as a quality, condition, genericness, etc. of the target item. In one example, a derived feature includes a depreciated value of the target item based on a price of the target item, an age of the target item, and a condition of the target item.

In some embodiments, enriching the normalized target item includes adding the extracted features to a representation of the normalized target item. In one non-limiting example where the normalized target item includes a JavaScript object notation (i.e., “JSON”) object, enriching the normalized target item includes adding the extracted features to the JSON object. Continuing the example of the normalized target item shown in Table 1, Table 2 illustrates a non-limiting example of an enriched normalized target item.

TABLE 2
Example Enriched Normalized Target Item

```
{
  id: '69ba75b0-342d-4e96-9c39-c27944f26987',
  description: 'Ralph Lauren Polo shirt',
  room: 'Master Bedroom',
  store: 'Ralph Lauren',
  quantity: 3,
  age: '0',
  price: '69.99',
  brand: 'Ralph Lauren',
  color: null,
  brand_url: 'www.ralphlauren.com',
  is_generic: false,
}
```

### Table 2: Example Enriched Normalized Target Item

As shown in Table 2, relative to the example shown in Table 1, the normalized target item is enriched with the brand, color, brand_url, and is_generic fields, which are extracted based on the normalized target item.

In various embodiments, the one or more features used to enrich the normalized target item are extracted using a trained AI model such as a large language model. In some embodiments, the trained AI model is trained or fine-tuned using training data that includes item descriptions and corresponding features of the items. In some embodiments, the trained AI model is trained or fine-tuned using examples of target item descriptions and corresponding features to be extracted. In some embodiments, an item description is provided as input to the trained AI model. The output of the AI model is then compared to the features of the items, and weights of the AI model are updated based on the comparison, such as by backpropagation.

In some embodiments, the normalized target item is enriched with a contextual insight. After block 306, process 300 continues to block 308.

At block 308, the enriched target item is classified. In some embodiments, the enriched target item is classified according to a classification scheme such as the American Moving and Storage Association Guide “AMSA,” or the Insurance Services Office (ISO) commercial general liability (CGL) classification system. In various embodiments, classification is performed using a trained AI model such as an LLM. In some embodiments, the classification is mapped to an expected life table. In some embodiments, the expected life table is used to determine depreciation of the target item. In various embodiments, the classification, expected life table, depreciation, or any combination thereof, are included in the enriched normalized target item. A non-limiting example of an enriched normalized target item including a classification is illustrated below in Table 3.

TABLE 3
Example Enriched Normalized Target Item with Classification

```
{
  id: '69ba75b0-342d-4e96-9c39-c27944f26987'
  description: 'Ralph Lauren Polo shirt',
  room: 'Master Bedroom',
  store: 'Ralph Lauren',
  quantity: 3,
  age: '0',
  price: '69.99',
  brand: 'Ralph Lauren',
  color: null,
  brand_url: 'www.ralphlauren.com',
  is_generic: false,
  depreciationClassification: 'Clothing: shirts, underwear, socks,
pajamas, lingerie, handkerchiefs'
}
```

As shown in Table 3, relative to Table 2, the field “depreciationClassification” is added, reflecting the classification of the enriched target item. After block 308, process 300 continues to block 310.

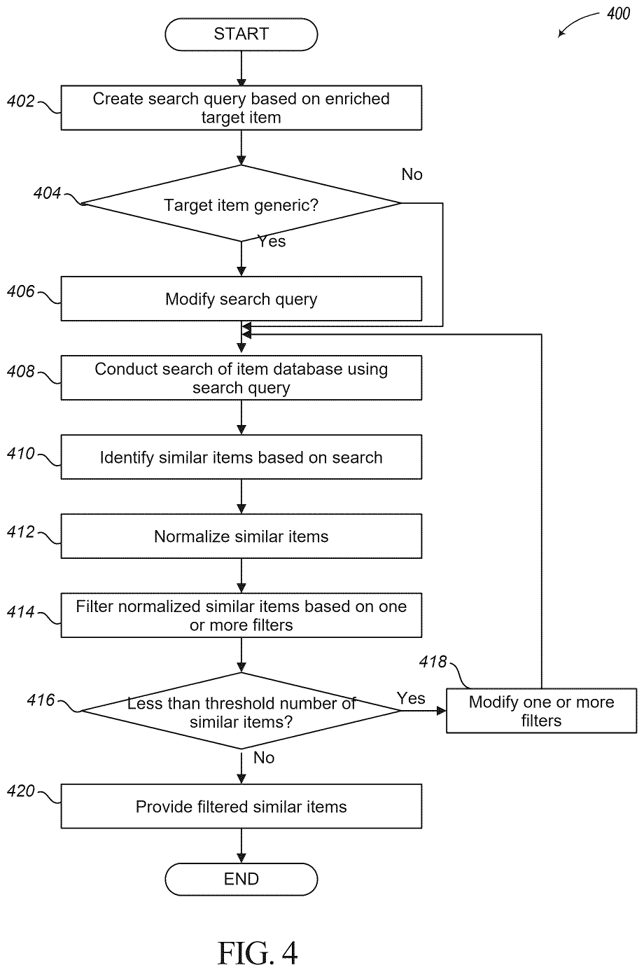

At block 310, one or more candidate items are identified based on the enriched target item. In various embodiments, block 310 employs embodiments of process 400 of FIG. 4 to identify the one or more candidate items based on the enriched target item. After block 310, process 300 continues to block 312.

At block 312, features of the one or more candidate items and the enriched target item are extracted. In various embodiments, block 312 employs embodiments described with respect to FIG. 7 to extract the features of the one or more candidate items and the enriched target item. After block 312, process 300 continues to block 314.

At block 314, a similarity score is determined for each candidate item based on the extracted features. In various embodiments, block 314 employs embodiments described with respect to FIG. 7 to determine a similarity score for each candidate item.

In various embodiments, the similarity score is determined using an objective scoring model configured to provide a similarity score based on expert-tuned criteria, independent of subjective policyholder sentiment to capture the like-kind and quality of candidate items to the target item.

In some embodiments, candidate items sharing many extracted features with the target item are assigned a relatively high similarity score, and candidate items sharing few extracted features with the target item are assigned a relatively low similarity score. In various embodiments, the objective scoring model determines the similarity scores based on quantitative data such as historical item values, item descriptions, or item meta data, user submitted data such as item descriptions, assumed pricing, age, quantity, place of purchase, normalized similar items and the normalized target item, deviation threshold (e.g., within 30% of acceptable price variance), expert feedback, etc., or any combination thereof.

In some embodiments, the deviation threshold indicates a maximum price variance of the candidate items from the target item. In one non-limiting example wherein the target item is a $ 1,000 couch and the deviation threshold is 30%, the candidate items have a maximum price variance of $300. After block 314, process 300 continues to block 316.

At block 316, candidate items satisfying a similarity threshold are selected. In various embodiments, block 316 employs embodiments described with respect to FIG. 8 to select candidate items satisfying the similarity threshold. After block 316, process 300 continues to block 318.

At block 318, a fairness score is determined for each selected candidate item. The fairness score quantifies user perception of fairness of the candidate items as substitutes for the target item. In various embodiments, the fairness score is determined based on survey data from users, sentiment analysis of open-ended responses, demographic or situational context (e.g., age, type of item), normalized candidate items and normalized target item, etc., or any combination thereof. In some embodiments, the fairness score is determined based on previous disputes, accepted resolutions of the previously accepted disputes, or both. In some embodiments, the fairness score is based on one or more other users accepting a dispute resolution based on a selected candidate item. In one non-limiting example, when ten other users accepted a dispute resolution based on the selected candidate item, a fairness score for the selected candidate item is increased relative to another candidate item which no other users have accepted as a substitute for the target item in a dispute. In various embodiments, block 318 employs embodiments described with respect to FIG. 9 to determine the fairness scores. While the example of a fairness score is used herein, in various embodiments the fairness score is a qualitative score indicating any other qualitative metric. In one example where the target item is an ingredient of a recipe, the fairness score is replaced with a flavor suitability score that captures a subjective flavor of the ingredient such that a substitute ingredient having a similar subjective flavor can be identified. After block 318, process 300 continues to block 320.

At block 320, a substitute item is selected from the selected candidate items based on the fairness scores. In various embodiments, block 320 employs embodiments described with respect to FIG. 10 to select the substitute item. After block 320, process 300 ends at an end block.

While not shown in FIG. 3, in various embodiments the substitute item is provided to a user device such as a device associated with an insurance adjustor, an insurance claimant, etc.

Additionally, while the example shown in process 300 uses the similarity scores to select the candidate substitution items and uses the fairness scores to select the substitution item, the disclosure is not so limited. In various embodiments, any combination of the fairness scores and the similarity scores is used to select the substitution item. In one example, candidate items are not explicitly determined. Fairness scores and similarity scores are calculated for the similar items, and the substitute item is selected based on a combination of the fairness scores and the similarity scores, such as a weighted combination.

FIG. 4 is a logical flow diagram illustrating a process 400 for identifying similar substitute items using an item database in some embodiments. In some embodiments, block 310 of FIG. 3 employs embodiments of process 400 to identify similar substitute items using an item database. In various embodiments, process 400 is implemented using substitution item search system 204 of FIG. 2.

Process 400 begins, after a start block, at block 402, where a search query is created based on the enriched target item. As described herein, the enriched target item may include various features of the target item such as a brand, age, condition, color, price, etc. In some embodiments, the search query is created to include one or more of these features. In some embodiments, the search query is based on a description of the target item provided by a user. In some embodiments, the description of the target item includes a textual description of the target item. In some embodiments, the description of the target item includes an image of the target item. In some embodiments, the search query is created using a generative artificial intelligence model such as a large language model. After block 402, process 400 proceeds to decision block 404.

At decision block 404, a determination is made whether the target item is generic. If yes, process 400 proceeds to block 406. If no, process 400 proceeds to block 408. In some embodiments, the determination is made based on an item description provided by the user, a feature of the enriched target item, or any combination thereof.

At block 406, the search query is modified based on the determination that the target item is generic. In some embodiments, the search query is modified to include a store at which the target item was purchased when the target item is generic. After block 406, process 400 continues to block 408.

At block 408, a search of an item database is conducted using the search query. In some embodiments, the item database includes a shopping service such as Google Shopping, Amazon, Bing Shopping, Walmart Marketplace, eBay, Etsy, Shopify, Alibaba, AliExpress, etc. In some embodiments, the search is performed using an application programming interface (i.e., an “API”) of the shopping service. In some embodiments, the search is conducted using multiple item databases. In some embodiments, attributes determined during the item enrichment phase are used to determine the correct database or databases to search. For example, if an item is classified as “home hardware”, databases of vendors of home hardware are searched. In some embodiments, geographic information associated with the target item is used to identify an item database to search. In one example, based on the target item being purchased or owned in Australia, item databases of Australian stores are searched to identify items more similar to the target item.

After block 408, process 400 continues to block 410.

At block 410, similar items are identified based on the search. In some embodiments, the similar items include each item identified in the search of the item database. After block 410, process 400 continues to block 412.

At block 412, the similar items are normalized. In various embodiments, block 412 employs embodiments of block 304 of process 300 described in FIG. 3 to normalize the similar items. After block 412, process 400 continues to block 414.

At block 414, the normalized similar items are filtered based on one or more filters. In some embodiments, the one or more filters are configured to filter out similar items that are sponsored using a sponsored results filter. In one-non-limiting example, a similar item provided by a shopping service is sponsored, which may modify its position in the search results provided by the shopping service. In some embodiments, the one or more filters are configured to filter out similar items that are duplicates.

In some embodiments, the one or more filters are configured to filter out similar items that do not include links. In one non-limiting example, it may not be practical to locate additional information about a similar item without a link to a website selling the similar item. Additionally, it may not be possible to purchase the similar item without a link.

In some embodiments, the one or more filters are configured to filter out similar items having a cost that differs from a reported value of the target item by more than a threshold. In one non-limiting example, when the target item is a couch costing $ 1,000 and the threshold is 60%, similar items costing less than $400 or more than $1,600 are filtered out. In various embodiments, the threshold is a percentage, a specified amount, etc.

In some embodiments, the one or more filters are configured to filter out similar items that are used, in poor condition, etc. After block 414, process 400 continues to decision block 416.

At decision block 416, a determination is made whether there is less than a threshold number of similar items. In various embodiments, the threshold number of similar items is 1, 3, 5, 10, etc. If yes, process 400 proceeds to block 418. If no, process 400 proceeds to block 420. In some embodiments, the threshold number of similar items is automatically determined based on a feature of the target item. In one example where the target item is a rare painting, it may be impractical to identify similar items. Accordingly, the threshold number of similar items is automatically set to a relatively low value such as 1, 2, or 3. In another example where the target item is a generic item, it may be practical to identify similar items. Accordingly, the threshold number of similar items is set to a relatively high value such as 10, 20, or 50.

At block 418, one or more filters are modified. In various embodiments, the one or more filters are modified such that a larger number of similar items is expected to be identified in search results. In some embodiments, a filter of the one or more filters is deactivated, a threshold of the filter is modified, etc. In one example, a price filter may be modified to include similar items in a larger price range than was previously used. In another example, a location filter is modified to include similar items in a larger geographic area. In another example, an item condition filter is changed to include used similar items or similar items in additional conditions. In another example, a retailer filter is modified to include retailers besides a retailer that originally sold the target item. In another example, a brand filter is modified to include brands of substitution items that do not exactly match a brand of the target item. After block 418, process 400 continues to block 408, where a second search of the item database is performed. In some embodiments, after block 418, process 400 continues to block 414, where the previous obtained search results are filtered according to the one or more modified filters.

At block 420, the filtered similar items are provided to a computing device. In some embodiments, the filtered similar items are provided to a system for determining a similarity score, such as similarity scoring system 206 of FIG. 2. After block 420, process 400 ends at an end block.

FIG. 5 is a block diagram 500 illustrating logic for obtaining one or more normalized target items in some embodiments. In some embodiments, blocks 302-308 of process 300 of FIG. 3 employ logic of block diagram 500 to obtain normalized target items 520. Block diagram 500 includes item normalization system 202, which generates normalized target items 520 based on item data 502. Item normalization system 202 includes pre-processing system 506 and classification system 512.

As shown in FIG. 5, data regarding one or more target items is obtained using item data 502. In some embodiments, the item data includes a loss sheet specifying items lost in a loss event such as a fire, flood, theft, etc. In various embodiments, the item data includes information regarding one or more items based on an online shopping cart of a user, a previous order of a user, a recipe, a materials list, etc. In general, the item data may be based on any item for which a substitute is sought.

The data may include a description of the one or more target items by a policyholder or other person associated with the one or more target items, images of the one or more target items, etc. In some embodiments where the data includes an image or video, optical character recognition (OCR) is performed on the image to obtain descriptions of the one or more target items using image parse system 504. In some embodiments, image parse system 504 extracts features from the image or video a description of the image using a convolutional neural network, a generative artificial intelligence model such as a language model, or another feature extraction model.

The descriptions of the one or more target items are normalized using item normalization model 508, such as using an artificial intelligence (AI) model configured to generate output according to a schema such as a JSON. In various embodiments, the one or more target items are normalized using a large language model such as GPT-4, Llama, Claude, etc. In some embodiments, the large language model is provided with a template with which to normalize the one or more target item descriptions, such as a JSON template. In some embodiments, the AI model is trained or fine-tuned using training data that includes target items and corresponding labels that include normalized target items.

In some embodiments, the one or more target item descriptions are enriched using item enrichment system 510. In some embodiments, item enrichment system 510 enriches the one or more target descriptions by extracting one or more features of the target item from the target item description, such as a brand, color, brand URL, genericness, etc. of the target item. In some embodiments, one or more of the extracted features are added to the normalized descriptions of the one or more target items. For example, an extracted feature may be added to a JSON of the target item.

In some embodiments, item enrichment system 510 enriches the normalized target item using a contextual insight. In some embodiments, the contextual insight identifies whether the target item is of particular subjective value. For example, a unique, sentimental, rare, or highly-used target item may be subjectively important despite having a relatively low face value. A painting made by a family member may be objectively similar to lower-valued paintings based on its workmanship, quality of materials, or fame of the artist. However, the painting is likely to have high sentimental value because it was made by the family member. Accordingly, the target item corresponding to the painting is enriched with a contextual insight indicating potentially high sentimental value. As discussed herein, the contextual insight may be used to influence selection of a substitution item for the target item or other target items. For example, based on a target normalized item being enriched with a contextual insight indicating high subjective importance, a relatively rarer or more valuable substitution item may be selected.

In one example, based on determining that the target item is a rare movie collectible indicative of a strong interest in movies, the contextual insight is an indication that a person associated with the item is interested in movies or collectibles.

In some embodiments, item enrichment system 510 uses the contextual insight to enrich other target items in a set of target items, for example, a set of target items lost in a home destroyed by a natural disaster. Continuing the example where the target item is a rare movie collectible, an indication that a person associated with the target item is interested in movies or collectibles is used to enrich other target items related to the rare movie collectible, movies, media consumption, collectibles, etc.

In some embodiments, item enrichment system 510 uses the contextual insight to enrich another normalized target item that may not be directly related to the target item. For example, a person highly interested in movies may be statistically less likely to be highly interested in outdoor sporting equipment. Accordingly, the contextual insight may be applied to outdoor sporting equipment in the set of target items.

In another example, the contextual insight is a quality of the target item. Based on the quality of the target item, a quality of other target items in the set of target items may be inferred. In one example, the contextual insight is that the target item is a luxury espresso machine. Based on the contextual insight, a quality of other kitchen appliances in the set of target items is affected. For example, where there is no description available for a coffee grinder in the set of target items, the contextual insight is applied to the coffee grinder to infer that the coffee grinder is a luxury coffee grinder.

In some embodiments, enriched target items generated using item enrichment system 510 are classified using classification system 512. Classification system 512 includes classification model 514, which classifies enriched target items. In various embodiments, classification model 514 includes a neural network-based classifier, a decision tree, a support vector machine, etc., or any combination thereof. In some embodiments, the one or more enriched target item descriptions are classified according to an AMSA or ISO CGL category. In some embodiments, the classification is mapped to an expected life table, such as to determine depreciation of the one or more target items. In some embodiments, item enrichment system 510 enriches the normalized target item description using a classification, expected life table, or both.

In some embodiments, the normalized target items 520 are used to search an item database for items similar to the target items, as discussed with respect to FIG. 4 and FIG. 6.

FIG. 6 is a block diagram 600 illustrating logic for identifying similar items based on a target item in some embodiments. Block diagram 600 includes substitution item search system 204, which generates normalized similar items 620 based on normalized target items 520. In various embodiments, the logic shown in FIG. 6 is usable to determine one or more normalized similar items based on the one or more normalized target items, as described with respect to FIG. 4.

Substitution item search system 204 includes item retrieval system 602, similar item normalization system 604, similar item enrichment system 606, results filtering system 608, and filter modification system 610.

Item retrieval system 602 uses normalized target items 520 to identify items similar to normalized target items 520. In some embodiments, item retrieval system 602 accesses an item database using communication network 106. In one example, item retrieval system 602 creates a search query for the item database based on normalized target items 520 and conducts a search of the item database using the search query. In some embodiments, based on a result of the search, item retrieval system 602 revises the search query and performs an updated search of the item database using the revised search query. In one example where the search identifies fewer than a threshold number of items, item retrieval system 602 revises the search query to be more inclusive, such as by modifying filters of the search query. In some embodiments, item retrieval system 602 access a local item database. In some embodiments, item retrieval system 602 implements blocks 402-410 of process 400 in FIG. 4.

Similar item normalization system 604 normalizes similar items identified using item retrieval system 602. In some embodiments, similar item normalization system 604 normalizes the similar items to a structured data format similar to that of normalized items 520. In some embodiments, similar item normalization system 604 uses embodiments of item normalization model 508 to normalize the similar items.

Similar item enrichment system 606 enriches the normalized similar items produced using similar item normalization system 604. In various embodiments, similar item enrichment system 606 operates similarly to item enrichment system 510 of FIG. 5.

Results filtering system 608 filters the enriched similar items produced using similar item enrichment system 606. In some embodiments, results filtering system implements block 414 of FIG. 4.

Filter modification system 610 modifies filters used by item retrieval system 602 to identify similar items using a feature of normalized target item 520 or the enriched similar items. In some embodiments, filter modification system 610 modifies filters used by results filtering system 608 using a feature of normalized target item 520 or the enriched similar items. In one example, filter modification system 610 adjusts a sponsored results filter of results filtering system 608 to include or exclude sponsored results from the similar items. In various embodiments, filter modification system 610 implements block 418 of FIG. 4.

FIG. 7 is a block diagram 700 illustrating logic for scoring similar items in some embodiments. Block diagram 700 includes similarity scoring system 206, which includes feature extraction models 706a through 706n (collectively, feature extraction models 706). Feature extraction models 706 are configured to extract one or more features of normalized similar items 702 and normalized target items 520. In some embodiments, normalized similar items 620 are produced using process 400 of FIG. 4 implemented by substitution item search system 204. In some embodiments, normalized target item 520 is produced using item normalization system 202.

In some embodiments, feature extraction models 706 include one or more AI models such as an LLM. In some embodiments, a feature extraction model is configured to extract a purpose or use of an item. In some embodiments, a feature extraction model is configured to extract one or more features of an item, such as a color, size, material, or make. In some embodiments, a feature extraction model is configured to extract a quality of the item.

In various embodiments, feature extraction models 706 include one or more of: a brand model configured to determine similarity of brand of the target item and a similar item; a price model configured to detect similarity of price of the target item and a similar item; a description model configured to detect similarity of description from target item and a similar item; a materials model configured to detects similarity of materials of construction of the target item and a similar item; a category model configured to detect similarity of item category of the target item and a similar item; an intended use model configured to detect similarity of intended use of the target item and a similar item; a store similarity model configured to detect similarity of store of item purchase of the target item and a similar item; a store reputation model configured to determine of a reputation of a store from which a similar item is purchased; an item availability model configured to detect whether a similar item is currently available for purchase; a shipping cost model configured to determine a shipping cost associated with a similar item; an item condition model configured to detect a similarity of condition of the target item and a similar item; an item weight model configured to detect a similarity of item weight of the target item and the similar item; an item size model configured to detect a similarity of item dimensions of the target item and a similar item; an image similarity model configured to detect similarity of item visual likeness of the target item and a similar item; and an obsolescence model configured to detects if the target item or a similar item is obsolete or no longer manufactured.

In some embodiments, an extracted feature is a number. In one non-limiting example, when the feature corresponds to a quality of an item on a scale of 1-10, the extracted feature is 7.8. In another non-limiting example, when the feature corresponds to a price of the item, the extracted feature is 100 (dollars, euros, etc.).

In some embodiments, the extracted feature is text-based. In one non-limiting example, when the feature corresponds to a textual description of a purpose of the item and the item is a couch, the extracted feature is “seats people”.

In various embodiments, a feature extraction model such as an LLM is trained or fine-tuned to extract a relevant feature based on a training dataset that includes normalized items and corresponding features.

In some embodiments, feature extraction models 706 includes one or more rules. For example, a feature extraction model may be configured to extract a feature, such as brand, from the normalized similar item or the normalized target item to similarity scoring model 708.

The extracted features of the normalized similar items and the normalized target item are provided to similarity scoring model 708, which is configured to determine a similarity score for each similar item based on the extracted features of the normalized similar item and the normalized target item.

In some embodiments, similarity scoring model 708 scores the similar items based on whether the similar item is exactly the same as or similar to the target item, has a same brand or similar brand as the target item, a price difference between the similar item and the target item, or any other extracted features.

In some embodiments, similarity scoring model 708 is based on a number or portion of features that match between the similar normalized item and the normalized target item. In one non-limiting example, when seven out of ten features match, the score is 7.

In some embodiments, similarity scoring model 708 is based on one or more rules, such as using a decision tree. In one non-limiting example, a difference of price between a normalized similar item and a normalized target item above a threshold reduces a score by a configurable amount.

In some embodiments where one or more of the extracted features are numbers, similarity scoring model 708 is based on a linear model, logistic model, etc.

In some embodiments, similarity scoring model 708 is based on a large language model or other AI model trained or fine-tuned to determine scores of similar items based on a training dataset including target items, similar items, and similarity scores for target item-similar item pairs.

Similarity scoring model 708 produces scored similar items 710. In some embodiments, scored similar items 710 includes normalized similar items 702 with corresponding similarity scores.

FIG. 8 is a block diagram 800 illustrating logic for filtering scored similar items to identify candidate substitution items in some embodiments. In various embodiments, candidate item selection system 208 produces candidate substitution items 804 by filtering out scored similar items from scored similar items 710 that have a similarity score lower than a configurable threshold. In some embodiments, the configurable threshold is based on a number of scored similar items. In one non-limiting example, the configurable threshold increases linearly, logarithmically, etc., based on the number of scored similar items. In some embodiments, the configurable threshold is automatically adjusted to produce a selected number of candidate substitution items form the scored similar items such as 1, 2, 5, 10, etc.

FIG. 9 is a block diagram 900 illustrating logic for determining fairness scores for candidate substitution items in some embodiments. Block diagram 900 includes fairness scoring system 210, which includes feature extraction models 904 and fairness scoring model 906. Feature extraction models 904a through 904n (collectively, feature extraction models 904) are configured to extract one or more features of candidate substitution items 804 and normalized target items 520. In various embodiments, feature extraction models 904 are similar to feature extraction models 706 of FIG. 7. In some embodiments, feature extraction models 706 include a sentimental item model configured to determine a sentimental value of a normalized target item. In various embodiments, the features extracted by feature extraction models 904 are the same or different from the features extracted by feature extraction models 706.

Fairness scoring model 906 is configured to produce fairness scored candidate substitution items 908. In various embodiments, fairness scoring model 906 is similar to similarity scoring model 708 of FIG. 7. In various embodiments, fairness scoring model 906 includes an artificial intelligence model trained or fine-tuned to determine a fairness score using training data that includes target items, candidate substitution items, and labels corresponding to a fairness of the candidate substitution items and substitutions for the target items. In some embodiments, the labels are created based on user input scoring the fairness in response to a prompt providing various information such as price, brand, an image, etc. for the candidate substitution items and the target items. In some embodiments, the AI model determines an overall fairness score that represents an overall fairness for substituting multiple target items with multiple candidate items.

In some embodiments, fairness scoring model 906 determines fairness scores using any classifier, such as a decision tree, artificial neural network-based classifier, or support vector machine. In some embodiments, fairness scoring module 906 determines fairness scores using a generative artificial intelligence model. In one example, fairness scoring model 906 provides the target item and the candidate substitution items to the generative artificial intelligence model with instructions to generate a fairness score for each candidate substitution item that captures a subjective fairness of substituting each candidate substitution item for the target item. Fairness scoring model 906 receives a response from the generative artificial intelligence model including the fairness scores.

In some embodiments, fairness scoring model 906 uses a contextual insight of a normalized target item to determine the fairness score. In one example where the contextual insight indicates that the normalized target item indicates an interest in autographed memorabilia, fairness scoring model 906 increases fairness scores of candidate substitution items that are autographed.

In some embodiments where the contextual insight indicates that the target item is subjectively valuable, fairness scoring model 906 increases the fairness score of a candidate item having an estimated value higher than an estimated value of the target item. In one example where a contextual insight indicates that the target item is a sentimental painting, fairness scoring model 906 assigns a higher fairness score to a painting that is more valuable than the sentimental painting.

In some embodiments where the contextual insight indicates that the normalized target item is subjectively less valuable, fairness scoring model 906 increases the fairness score of a candidate item having an estimated value less than an estimated value of the target item. In one example where the target item is a ten-year-old inflatable kayak in new condition, the contextual insight indicates that the kayak is infrequently used and may have a lower subjective value. Accordingly, fairness scoring model 906 may increase a fairness score of a substitution kayak that is less valuable than the target item.

As discussed herein, in various embodiments, fairness scoring model 906 uses a contextual insight of a first normalized target item to determine a fairness score for a second normalized target item.

FIG. 10 is a block diagram illustrating logic for determining proposed substitution items 1004 in some embodiments. Substitution item selection system 212 is configured to select proposed substitution items 1004 based on candidate items with fairness scores 906. In some embodiments, substitution item selection system 212 is configured to optimize fairness with respect to each target item (e.g., “item-level optimization”) using item-level optimization model 1002a. For example, when target items include a couch and a car, substitution item selection system 212 selects a candidate substitution item having a highest fairness score for the couch and a candidate substitution item having a highest fairness score for the car. In some embodiments, substitution item selection system 212 is configured to optimize fairness across two or more of the target items (e.g., “claim-level optimization”) using item set-level optimization model 1002b. For example, when the target items include the couch and the car, a substitute couch and a substitute car that maximize an overall fairness are selected. In some embodiments, substitution item selection system 212 includes an AI model. In some embodiments, substitution item selection system 212 includes one or more rules, linear regression models, etc.

In some embodiments, substitution item selection system 212 uses a substitution constraint to select the substitution item. The substitution constraint may be a limit on a value of the substitution item, a cumulative value of a set of substitution items, a policy limit associated with the target item, or any other constraint on the substitution items. For example, based on a substitution constraint indicating that a cumulative value of a set of substitution items is not to exceed $1,000,000, item set-level optimization model 102b selects the proposed substitution items such that a cumulative value of the set of substitution items does not exceed $1,000,000.

In some embodiments, substitution item selection system 212 flags the target item for review based on a difference in value between the substitution item and the target item exceeding a threshold. The threshold may be a specified value, such as $1,000, $10,000, etc., a percentage of a value of the target item, such as 10%, or any combination thereof. For example, where the target item is a vintage model of a car worth $100,000 and the substitution item is a new model of the car worth $70,000, the difference in value is $30,000. Based on the difference of value exceeding the threshold, substitution item selection system 212 flags the target item for review.

In some embodiments, substitution item selection system 212 selects the substitution item based on any combination of the fairness scores and the similarity scores corresponding to the similar items. In one example, substitution item selection system 212 compares weighted combinations of the fairness score and the similarity score for each candidate substitution item, and selects the candidate substitution item having a highest weighted combination as the substitution item. In some embodiments, weights of the weighted combination are determined based on a contextual insight of the target item. In one example, based on the contextual insight indicating a high subjective importance of the target item, a weight of the fairness score relative to the similarity score is increased. In another example, based on the contextual insight indicating a low subjective importance of the target item, a weight of the fairness score relative to the similarity score is decreased.

In some embodiments, substitution item selection system 212 selects the substitution item by comparing the fairness score to a fairness threshold, comparing the similarity score to a similarity threshold, or comparing a combination of the similarity score and the fairness score to a combined threshold. In one example, substitution item selection system 212 selects a candidate substitution item as the substitute item based on its similarity score satisfying a similarity threshold and its fairness score satisfying a fairness threshold. In some embodiments, the fairness threshold, similarity threshold, or combined threshold is based on a contextual insight of the target item. In one example where the contextual insight indicates that the target item is rare or collectible, the combined threshold is set relatively high to ensure that the selected substitution item is highly fair and similar to the target item.

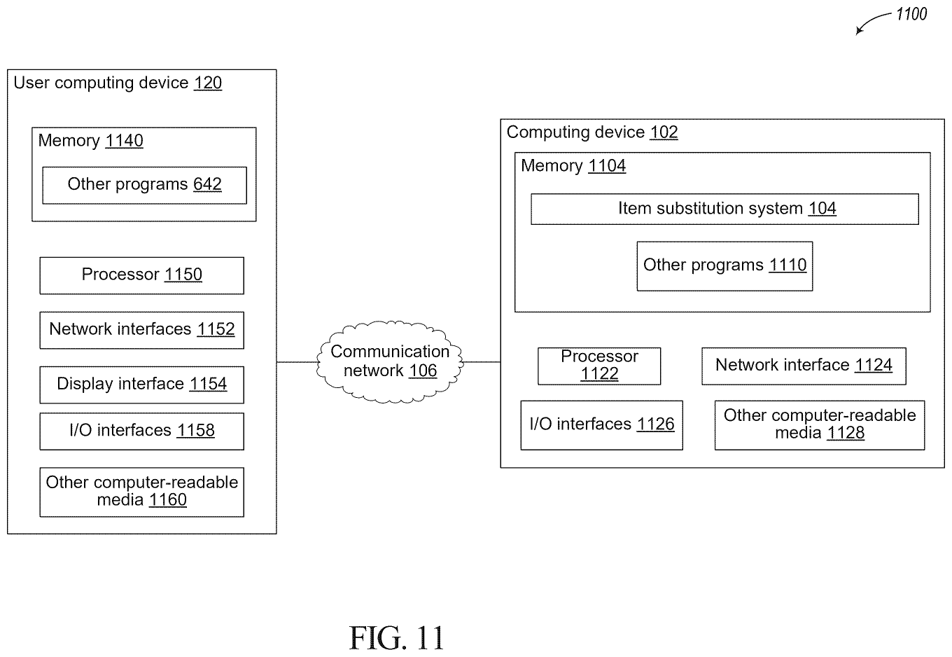

FIG. 11 is a system diagram illustrating one implementation of a computing system 1100 usable for implementing embodiments described herein. Computing system 1100 includes computing device 102 and user computing device 120.

Computing device 102 includes memory 1104, processor 1122, network interface 1124, input/output (I/O) interfaces 1126, and other computer-readable media 1128.

Processor 1122 includes one or more processors, one or more processing units, programmable logic, circuitry, or one or more other computing components that are configured to perform embodiments described herein or to execute computer instructions to perform embodiments described herein. In some embodiments, a processor system of computing device 102 includes a single processor 1122 that operates individually to perform actions. In some embodiments, a processor system of computing device 102 includes a plurality of processors 1122 that operate to collectively perform actions, such that one or more processors 1122 may operate to perform some, but not all, of such actions.

Memory 1104 may include one or more various types of non-volatile or volatile storage technologies. Examples of memory 1104 include, but are not limited to, flash memory, hard disk drives, optical drives, solid-state drives, various types of random-access memory (“RAM”), various types of read-only memory (“ROM”), other computer-readable storage media (also referred to as processor-readable storage media), or other memory technologies, or any combination thereof. Memory 1104 may be utilized to store information, including computer-readable instructions that are utilized by a processor system of one or more processors 1122 to perform actions, including at least some embodiments described herein.

Memory 1104 may have stored thereon item substitution system 104 of FIG. 1, as described herein. Memory 1104 may also store other programs 1110.

Network interface 1124 is configured to communicate with other computing devices, such as user computing device 120. I/O interfaces 1126 may include interfaces for various input or output devices, such as USB interfaces, physical buttons, keyboards, haptic interfaces, tactile interfaces, or the like. Other computer-readable media 1128 may include other types of stationary or removable computer-readable media, such as removable flash drives, external hard drives, or the like.

In various embodiments, components of user computing device 120 are similar to corresponding components described with respect to computing device 102. In some embodiments, display interface 1154 includes a display configured to output images.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
identifying a target item for which a substitution item is to be determined;
searching, a database of items to identify one or more similar items that are similar to the target item;
extracting features of the target item and the one or more similar items using one or more feature extraction models;
determining a similarity score for the target item and each similar item based on the extracted features;
identifying one or more candidate items from the similar items, wherein the one or more candidate items have a similarity score above a similarity threshold;
determining a fairness score for each of the one or more candidate items; and
selecting a substitution item from the one or more candidate items based on the fairness score.

2. The method of claim 1, wherein identifying the target item includes identifying the target item from a loss sheet.

3. The method of claim 1, further comprising:
providing the selected substitution item to a user computing device.

4. The method of claim 1, wherein determining the fairness score includes determining the fairness score using a fairness scoring system that includes an artificial intelligence model.

5. The method of claim 1, wherein determining the similarity score includes determining the similarity score using a similarity scoring system that includes an artificial intelligence model.

6. The method of claim 1, wherein extracting features includes extracting features using an AI model.

7. The method of claim 1, wherein the extracted features are determined based on a type or characteristic of the target item.

8. The method of claim 1, comprising:
determining a contextual insight regarding the target item; and
determining the fairness score based on the contextual insight.

9. The method of claim 1, comprising:
determining a contextual insight for the target item, wherein the contextual insight indicates a demographic of a person associated with the target item; and
determining the fairness score based on the contextual insight.

10. The method of claim 1, comprising:
based on a difference of value between the target item and the substitution item exceeding a threshold, flagging the target item for review.

11. The method of claim 1, comprising:
determining a contextual insight for the target item; and
identifying a second substitute item for a second target item using the contextual insight.

12. The method of claim 1, comprising:
identifying the target item from an input image or video; and
based on determining that the input image or video is synthetic or altered, exists in an image or video database, or includes metadata inconsistent with the target item, flagging the input image or video for review.

13. The method of claim 1, comprising:
determining a contextual insight indicating a subjective importance of the target item; and
determining the fairness score based on the contextual insight.

14. The method of claim 1, comprising:
obtaining a substitution constraint for the target item; and
selecting the substitution item based on the substitution constraint.

15. The method of claim 1, comprising:
determining a similarity of the target item to a known pattern of fraud; and
based on the similarity being above a threshold, flagging the target item for review; and
providing a notification requesting review of the target item to a user device.

16. A system, comprising:
one or more memories collectively configured to store computer instructions; and
one or more processors configured to execute the computer instructions to:
identify a target item;
search, based on the target item, a database of items to identify one or more similar items;
determine candidate items based on a similarity score for each similar item with respect to the target item;
calculate a fairness score for each candidate item with respect to the target item; and
select a substitution item from the candidate items based on the fairness scores.

17. The system of claim 16, wherein the one or more processors determine the similarity score for each candidate item by being further configured to:
extract features for the target item and the similar items; and
calculate the similarity score based on the extracted features.

18. A non-transitory computer-readable storage medium that stores instructions executable by a processor to cause the processor to perform actions, the actions comprising:
identifying a plurality of target items;
searching, based on the plurality of target items, a database of items to identify candidate items for each target item of the plurality of target items;
determining a similarity score for each candidate item;
determining a fairness score for each candidate item; and
selecting a substitution item for each target item of the plurality of target items from the respective candidate items based on the similarity scores and the fairness scores.

19. The non-transitory computer-readable storage medium of claim 18, the actions comprising:
determining a contextual insight for a first target item of the plurality of target items; and
selecting a substitution item for the first target item based on the contextual insight for the first target item.

20. The non-transitory computer-readable storage medium of claim 18, the actions comprising:
selecting the substitution item for each target item based on a substitution constraint.
